(19) United States
(12) Patent Application Publication
(10) Pub. No.: US 2026/0325975 A1
(43) Pub. Date: Oct. 22, 2026

(54) SOFTWARE APPLICATIONS FOR ONLINE GAMING, VIRTUAL REALITY, AND VIDEO GAMES FOR GOLF PLAY

(71) Applicant: Wolfhammer PLLC, Gallatin, TN (US)

(72) Inventors: Terrence FRAZIER, Gallatin, TN (US); Jake CARTER, Gallatin, TN (US)

(73) Assignee: Wolfhammer PLLC, Gallatin, TN (US)

(21) Appl. No.: 19/391,080

(22) Filed: Nov. 17, 2025

Related U.S. Application Data
(60) Provisional application No. 63/721,371, filed on Nov. 15, 2024.

(51) Int. Cl. A63F 13/812

(52) U.S. Cl. CPC A63F 13/812

(57) ABSTRACT

Devices and system are provided that facilitating obtaining or transferring of data indicative of two or more player golf shots, and converting such data into hardware and/or software usable format whereby the players can virtually and/or in a simulation compete in a match format.

### CROSS-REFERENCE TO RELATED APPLICATIONS

This application claims priority to prior U.S. Provisional Patent Application No. 63/721,371, filed Nov. 15, 2024, the entire content of which is incorporated herein by reference.

### BACKGROUND

Generally, exemplary embodiments of the present disclosure relate to methodologies and devices applicable to virtual reality (VR) and/or simulation game play.

### SUMMARY OF THE DISCLOSURE

Exemplary embodiments of the present disclosure provide systems and methods for obtaining and/or transferring a first data indicative of at least a first golf shot of a first player; obtaining and/or transferring a second data indicative of at least a second golf shot of a second player; and converting the first data and the second data into a hardware and/or software usable format, whereby the first payer and the second player are competing based on the data via a virtual and/or a simulation-based computer implementation.

According to other exemplary implementations of any of the foregoing combinations, obtaining of at least one of the first data or the second data comprises acquiring the first data or the second data via an api of one or more third party providers.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIGS. 1A, 1B, and 1C are graphical representations of exemplary implementations of example embodiments of the disclosure.

FIG. 2 is a graphical representation of an exemplary implementation of a methodology according to example embodiments of the disclosure.

FIG. 3 is an example of an implementation of example embodiments of the disclosure.

FIGS. 4A, 4B, 4C, 4D, and 4E are graphical representations of an exemplary implementation of example methodologies and user interfaces according to example embodiments of the disclosure.

### DESCRIPTION OF EXEMPLARY EMBODIMENTS OF DISCLOSURE

The matters exemplified in this description are provided to assist in a comprehensive understanding of exemplary embodiments of the disclosure. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

As would be readily appreciated by skilled artisans in the relevant art, while descriptive terms such as “configuration”, “simulator”, “visual”, “virtual”, “integrated”, “screen”, “match”, “play”, “recorded”, “control”, “encoder”, “decoder”, “hardware”, “software”, “application”, “prototype”, and others are used throughout this specification to facilitate understanding, it is not intended to limit any components that can be used in combinations or individually to implement various aspects of the embodiments of the present disclosure.

Exemplary embodiments of the present disclosure provide methods and systems for facilitating of obtaining and/or transferring of the data indicative of a first player's golf shot, obtaining and/or transferring of the data indicative of a second player's golf shot, and converting such data into hardware and/or software usable format whereby first and second players can virtually and/or in a simulation compete in a match format.

According to exemplary implementations, data indicative of a first player's golf shot can comprise data from a professional player's golf shot, essentially allowing an individual (a second player) to play the professional player in real time or recorded time shot for shot on the course in a simulator and/or virtual reality application.

According to exemplary embodiments of the present disclosure, method and system can comprise hardware and software that facilitate obtaining of data via an api with simulator companies and professional tour players api shot data (or the professional players shot data publicly available, which may not be in real time).

According to further exemplary simulator and/or virtual reality application can include, without limitation same weather simulated conditions of said professional player's golf shot.

In yet another exemplary implementation, for example and without limitation, simulations can comprise more than two players, and can comprise team event with groups of individuals versus a professional player or teammates virtually with a professional player as a teammate or opponent:

According to exemplary embodiments of the present disclosure, method and system can comprise hardware and software that facilitate obtaining of data from shot of professional player (a first player), laying such data into, for example, a virtual reality simulator format and then have a player (a second player) hitting simulated shots on same hole to compete with the professional player.

In an exemplary implementation, a method or system built can include at least the following: mobile application, online gaming, virtual reality, video games or computer software.

While the present disclosure has been shown and described with reference to certain exemplary embodiments thereof, it will be understood by those skilled in the art that various changes in form and details may be made therein without departing from the spirit and scope of the embodiments of the present disclosure. Furthermore, any of the features or elements of any exemplary implementations of the embodiments of the present disclosure as describes above and illustrated in the drawing figures can be implemented individually or in any combination(s) as would be readily appreciated by skilled artisans without departing from the spirit and scope of the embodiments of the present disclosure. Still further, for example and without limitation, various features and combinations thereof of exemplary disclosed embodiments can be added to, or implemented in, simulator software such that, for example, simulations and/or games according to exemplary implementations can be offered inside a third party system, for example through an enterprise solution.

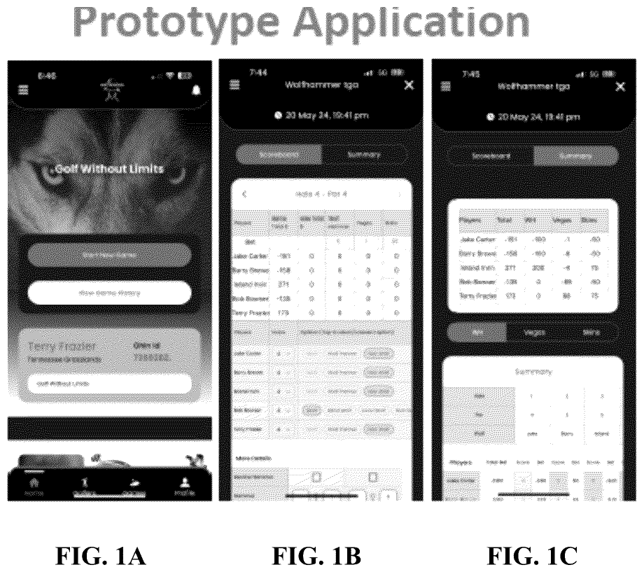

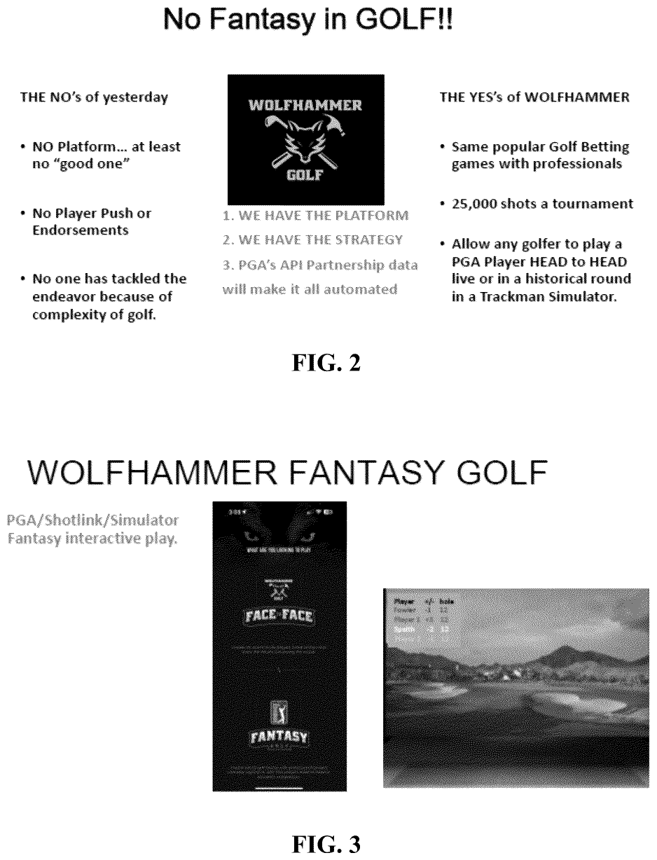

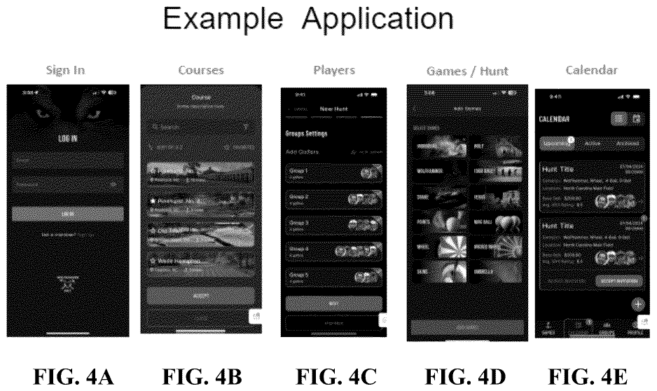

In addition, the included drawing figures, FIGS. 1A, 1B, 1C, 2, 3, 4A, 4B, 4C, 4D, and 4E, further describe non-limiting examples of implementations of certain exemplary embodiments of the present disclosure and aid in the description of technology associated therewith. Any specific terminology provided in the drawings, other than as explicitly stated above, are exemplary and not intended to limit the scope or content of the inventive design or methodology as understood by artisans skilled in the relevant field of disclosure.

The above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and so on, including a carrier wave transmitting signals specifying the program instructions, data structures, and so on. Examples of program instructions include both machine code, such as produced by a compiler, and files containing higher level code that may be executed by the computer using an interpreter. The described hardware devices may be configured to act as one or more software modules in order to perform the operations of the above-described embodiments of the present disclosure.

Other objects, advantages and salient features of the disclosure will become apparent to those skilled in the art from the details provided, which, taken in conjunction with the annexed drawing figures and Appendices, disclose exemplary embodiments of the disclosure.

1. A method comprising:
obtaining and/or transferring a first data indicative of at least a first golf shot of a first player;
obtaining and/or transferring a second data indicative of at least a second golf shot of a second player; and
converting said first data and said second data into a hardware and/or software usable format,
whereby said first payer and said second player are competing based on said data via a virtual and/or a simulation-based computer implementation.

2. The method of claim 1, wherein
said obtaining of at least one of said first data or said second data comprised acquiring said first data or said second data via an api of one or more third party providers.
